(19) United States
(12) Patent Application Publication
(10) Pub. No.: US 2016/0318005 A1
(43) Pub. Date: Nov. 3, 2016

(54) EXHAUST GAS PURIFYING CATALYST

(71) Applicant: Mitsui Mining & Smelting Co., Ltd., Tokyo (JP)

(72) Inventors: Yunosuke NAKAHARA, Saitama (JP); Kazuya KINOSHITA, Saitama (JP); Hiroaki OKUMURA, Shizuoka (JP); Fumikazu KIMATA, Shizuoka (JP); Toyofumi TSUDA, Shizuoka (JP)

(21) Appl. No.: 15/141,536

(22) Filed: Apr. 28, 2016

(30) Foreign Application Priority Data
Apr. 30, 2015 (JP) 2015-093286

(51) Int. Cl. B01J 23/89; B01J 35/02

(52) U.S. Cl. CPC B01J 23/8986; B01J 23/894; B01J 35/023

(57) ABSTRACT

The invention relates an exhaust gas purifying catalyst containing Fe and Ce, and a new catalyst for exhaust gas which can further enhance the excellent durability to a severe temperature change is provided.

Provided is an exhaust gas purifying catalyst which contains catalyst particles having a configuration in which iron (Fe), cerium (Ce), and a precious metal, and one or two or more kinds of elements (referred to as the “M element”) among cobalt (Co), manganese (Mn), copper (Cu), nickel (Ni), magnesium (Mg), lanthanum (La), and strontium (Sr) are supported on inorganic porous support particles, and in which catalyst particles having a configuration in which Ce is present at 1 at % or more, Fe is present at 0.1 at % or more, and the M element is present at 0.1 at % or more account for 80 or more when 100 of catalyst particles having a particle diameter of 6 μm or more are randomly selected and each of these catalyst particles is quantitatively mapped by EDX.

### TECHNICAL FIELD

The present invention relates to an exhaust gas purifying catalyst which can be used to purify exhaust gas discharged from an internal combustion engine.

### BACKGROUND ART

Harmful components such as hydrocarbons (HC), carbon monoxide (CO), and nitrogen oxides (NOx) are contained in the exhaust gas from motor vehicles using gasoline as the fuel. The respective harmful components are required to be purified using a catalyst so that the hydrocarbons (HC) are converted into water and carbon dioxide by oxidation, the carbon monoxide (CO) is converted into carbon dioxide by oxidation, and the nitrogen oxides (NOx) are converted into nitrogen by reduction.

As the catalysts for treating such exhaust gas (hereinafter, referred to as the “exhaust gas purifying catalyst”), three way catalysts (TWC) capable of oxidizing and reducing CO, HC, and NOx are used.

As such a three way catalyst, those which are obtained by supporting a precious metal such as platinum (Pt), palladium (Pd), or rhodium (Rh) on a refractory oxide porous material having a large specific surface area, for example, alumina porous material and then supporting this on a substrate, for example, a monolithic substrate having a refractory ceramic or metal honeycomb structure are known.

In this kind of three way catalyst, the precious metal has a function to convert the nitrogen oxides in the exhaust gas into nitrogen by reduction as well as to convert the hydrocarbons into carbon dioxide and water and carbon monoxide into carbon dioxide by oxidation, and it is preferable to maintain the ratio of the air to the fuel (air-fuel ratio) at the stoichiometric air-fuel ratio in order to effectively and simultaneously exert the catalytic action for these two reactions.

The air-fuel ratio of the internal combustion engine of a motor vehicle or the like greatly fluctuates depending on the driving situation such as acceleration, deceleration, a low speed driving, or a high speed driving, and thus the air-fuel ratio (A/F) fluctuating by the operating conditions of the engine is controlled to be constant by using an oxygen sensor (for example, stabilized zirconia). However, the catalyst cannot sufficiently exert the purifying performance as a catalyst by only controlling the air-fuel ratio (A/F) in this manner, and thus the catalyst layer itself is also required to exhibit the action of controlling the air-fuel ratio (A/F). Hence, a catalyst obtained by adding a promoter to a precious metal of the catalytically active component is used for the purpose of preventing a decrease in purifying performance of the catalyst caused by a change in air-fuel ratio by the chemical action of the catalyst itself.

As such a promoter, a promoter (referred to as the “OSC material”) is known which has the oxygen storage capacity (OSC) to release oxygen in a reducing atmosphere and to absorb oxygen in an oxidizing atmosphere. For example, ceria (cerium oxide, CeO₂) or ceria-zirconia composite oxide, and the like are known as the OSC material having oxygen storage capacity.

By the way, the price of a precious metal is high so as to be said that the price of the catalyst mostly attributes to the precious metal, and thus the development of a new catalytically active component to replace the precious metal has been carried out, and a catalyst for exhaust gas has been proposed which contains iron (Fe) as the catalytically active component among them.

For example, a catalyst having a configuration in which iron oxide is dispersed in ceria-zirconia composite oxide and is at least partially in a solid solution state is disclosed in Patent Document 1 (JP 2008-18322 A).

An exhaust gas purifying catalyst composed of carbon (C), iron (Fe), and cerium (Ce) is disclosed in Patent Document 2 (JP 2012-50980 A).

In addition, an exhaust gas purifying catalyst having a configuration in which a mixture containing iron carbide (Fe₃C) that is a compound of iron (Fe) and carbon (C) and cerium (Ce) is supported on an inorganic porous powdery support is disclosed in Patent Document 3 (JP 2014-42880 A) as well, and it is described that sintering of the exhaust gas purifying catalyst is suppressed even when being exposed to a high temperature of 900 to 1,000° C. as a mixture containing iron carbide (Fe₃C) and cerium (Ce) is supported on an inorganic porous powdery support, and as a result, the exhaust gas purifying catalyst exhibits high durability and can exert stable purifying performance at a high level even though the flow rate of the exhaust gas changes.

### CITATION LIST

### Patent Document

Patent Document 1: JP 2008-18322 A

Patent Document 2: JP 2012-50980 A

Patent Document 3: JP 2014-42880 A

### SUMMARY OF THE INVENTION

### Problem to be Solved by the Invention

The catalyst for motor vehicle is required to exhibit the performance which can exert stable purifying performance even though the flow rate of exhaust gas changes in addition to durability to a severe temperature change. However, it has been found that there is a tendency that the surface area of the exhaust gas catalyst is decreased by sintering and the catalytic activity deteriorates when the exhaust gas purifying catalyst is subjected to the heat treatment for a long time at a high temperature of 900 to 1,000° C. in the air in accordance with the actual use conditions. Especially, a catalyst containing iron (Fe) and cerium (Ce) has a problem of strongly tending to be sintered in a high temperature environment as described above.

Accordingly, an object of the invention is to provide a new catalyst for exhaust gas which can achieve further improvement of an exhaust gas purifying catalyst containing Fe and Ce and further enhance the excellent durability to a severe temperature change.

### Means for Solving Problem

In order to achieve the above object, the invention proposes an exhaust gas purifying catalyst which contains catalyst particles having a configuration in which iron (Fe), cerium (Ce), and a precious metal, and one or two or more kinds of elements (referred to as the “M element”) among cobalt (Co), manganese (Mn), copper (Cu), nickel (Ni), magnesium (Mg), lanthanum (La), and strontium (Sr) are supported on inorganic porous support particles, and in which catalyst particles having a configuration in which Ce is present at 1 at % or more, Fe is present at 0.1 at % or more, and the M element is present at 0.1 at % or more account for 80 or more when 100 of catalyst particles having a particle diameter of 6 μm or more are randomly selected and each of these catalyst particles is quantitatively mapped by EDX.

### Effect of the Invention

In the exhaust gas purifying catalyst proposed by the invention, the fact that the catalyst particles having a configuration in which Ce is present at 1 at % or more, Fe is present at 0.1 at % or more, and the M element is present at 0.1 at % or more account for 80 or more, namely, most when the catalyst particles are quantitatively mapped by EDX indicates that the catalyst particles in which Ce, Fe, and the M element are uniformly supported on the inorganic porous support without being unevenly distributed, respectively, account for most of the exhaust gas purifying catalyst proposed by the invention. It has been found that it is possible to suppress the sintering even when the exhaust gas purifying catalyst is exposed to a high temperature as a result that the catalyst particles in which Ce, Fe, and the M element are uniformly supported on the inorganic porous support without being unevenly distributed, respectively, account for most of the exhaust gas purifying catalyst in this manner. Hence, the exhaust gas purifying catalyst proposed by the invention exhibits much higher durability to a severe temperature change and can exert stable purifying performance at a much higher level.

### BRIEF DESCRIPTION OF DRAWINGS

FIG. 1 is an EDX Mapping photograph for the sample obtained in Comparative Example 1 and a diagram illustrating (A) an SEM image, (B) the distribution of aluminum (Al), (C) the distribution of cerium (Ce), (D) the distribution of iron (Fe), and (E) the distribution of cobalt (Co);

FIG. 2 is an EDX Mapping photograph for the sample obtained in Example 1 and a diagram illustrating (A) an SEM image, (B) the distribution of aluminum (Al), (C) the distribution of cerium (Ce), (D) the distribution of iron (Fe), and (E) the distribution of cobalt (Co);

FIG. 3 is an EDX Mapping photograph for the sample obtained in Example 14 and a diagram illustrating (A) an SEM image, (B) the distribution of aluminum (Al), (C) the distribution of cerium (Ce), (D) the distribution of iron (Fe), and (E) the distribution of cobalt (Co);

FIG. 4 is an EDX Mapping photograph for the sample obtained in Example 15 and a diagram illustrating (A) an SEM image, (B) the distribution of aluminum (Al), (C) the distribution of cerium (Ce), (D) the distribution of iron (Fe), and (E) the distribution of cobalt (Co); and

FIG. 5 is a graph illustrating the crystallite diameters, namely the degrees of sintering after the aging test of the catalyst powders obtained in Examples and Comparative Examples using various kinds of elements as the M element for comparing with one another.

### MODE(S) FOR CARRYING OUT THE INVENTION

Next, embodiments of the invention will be described. However, the invention is not limited to the embodiments to be described below.

<Exhaust Gas Purifying Catalyst>

The exhaust gas purifying catalyst (referred to as the “present catalyst”) as an example of embodiments of the invention is an exhaust gas purifying catalyst (referred to as the “present catalyst”) which contains catalyst particles (referred to as the “present catalyst particles”) having a configuration in which iron (Fe), cerium (Ce), and a precious metal, and one or two or more kinds of elements (referred to as the “M element”) among cobalt (Co), manganese (Mn), copper (Cu), nickel (Ni), magnesium (Mg), lanthanum (La), and strontium (Sr) are supported on inorganic porous support particles.

It is possible to effectively suppress the growth of the crystallite diameter of the precious metal as well as to improve the oxidation performance of the present catalyst as a catalyst as it contains the M element.

The present catalyst may be those which are composed only of the present catalyst particles or those which contain another component, for example, other particles such as an OSC material in addition to the present catalyst particles.

<Present Catalyst Particles>

In the present catalyst particles, it is preferable that iron (Fe), cerium (Ce), the M element, and the precious metal are supported on an inorganic porous support in a mixed state.

Here, the “mixed state” means a state in which iron (Fe), cerium (Ce), the M element, and the precious metal are respectively present without forming a chemical bond to one another.

In addition, in the present catalyst particles, it is preferable that iron (Fe), cerium (Ce), the M element, and the precious metal are supported on an inorganic porous support without being unevenly distributed, respectively.

It is possible to further suppress sintering of the present catalyst even when being exposed to a high temperature as iron (Fe), cerium (Ce), the M element, and the precious metal are supported on an inorganic porous support without being unevenly distributed, respectively, that is, in a uniformly dispersed state.

The fact that iron (Fe), cerium (Ce), the M element, and the precious metal are supported on an inorganic porous support without being unevenly distributed, respectively, can be confirmed, for example, using the mapping data for each of the elements.

For example, the fact can be confirmed by determining whether the catalyst particles having a configuration in which Ce is present at 1 at % or more, Fe is present at 0.1 at % or more, and the M element is present at 0.1 at % or more account for 80 or more, preferably 85 or more, and particularly preferably 90 or more when 100 of catalyst particles having a particle diameter of 6 μm or more are randomly selected and each of these catalyst particles is quantitatively mapped by EDX.

It is preferable that the catalyst particles having a configuration in which Ce is present at 1 at % or more and Fe and the M element are respectively present at 0.1 at % or more account for the number of particles described above from the viewpoint that cerium (Ce), iron (Fe), and the M element are supported on an inorganic porous support without being unevenly distributed, respectively.

Incidentally, the reason why the catalyst particles having a particle diameter of 6 μm or more are selected and quantitatively mapped by EDX is that it is difficult to accurately measure the amount (concentration) of element even if the catalyst particles having a particle diameter of less than 6 μm are quantitatively mapped by EDX.

In addition, it is preferable that the total atomic concentration of iron (Fe) is 0.1 to 20 at %, the total atomic concentration of cerium (Ce) is 1 to 36 at % and 1 to 30 at % among them, and the total atomic concentration of the M element is 0.1 to 10 at %.

At this time, from the viewpoint of sintering suppressing effect, the total atomic concentration of iron (Fe) is preferably 0.1 to 20 at % and it is even more preferably 0.5 at % or more or 10 at % or less among them and 2 at % or more or 5 at % or less among them.

From the viewpoint of sintering suppressing effect, the total atomic concentration of cerium (Ce) is also preferably 1 to 36 at %, it is particularly preferably 1 to 30 at % among them, and it is even more preferably 3 at % or more or 25 at % or less among them and 6 at % or more or 20 at % or less among them.

From the viewpoint of sintering suppressing effect, the total atomic concentration of the M element is also preferably 0.1 to 10 at % and it is even more preferably 1 at % or more or 10 at % or less among them and 2 at % or more or 10 at % or less among them.

Incidentally, the total atomic concentration of each element means the total amount of each element blended when the present catalyst is produced, namely, the amount of each element blended when the present catalyst is produced, and it is the total amount (total concentration) of the amount (concentration) of element supported on the inorganic porous support, the amount (concentration) of element unsupported, and the amount (concentration) of inorganic porous support.

The total atomic concentration of the M element is the total concentration thereof in the case of containing two or more kinds of M elements.

At this time, it is preferable that the catalyst particles in which the atomic concentration (at %) of Ce measured by quantitative mapping is 15% or more of the total atomic concentration (100 at %) of Ce account for 80 or more, 85 or more among them, and 90 or more among them when 100 of catalyst particles having a particle diameter of 6 μm or more are randomly selected and each of these catalyst particles is quantitatively mapped by EDX.

The fact that the catalyst particles in which the atomic concentration (at %) of Ce measured by quantitative mapping is 15% or more of the total atomic concentration (100 at %) of Ce account for 80 or more indicates that the atomic concentration of Ce supported on the inorganic porous support is relatively high with respect to the total atomic concentration, namely, the blended amount of Ce.

When the atomic concentration of Ce supported on the inorganic porous support is relatively high with respect to the blended amount, namely, the added amount of Ce, it is possible to further suppress sintering of the present catalyst in the case of being exposed to a high temperature, to exhibit much higher durability to a severe temperature change, and to obtain stable purifying performance at a much higher level.

From this point of view, it is even more preferable that the catalyst particles in which the atomic concentration (at %) of Ce measured by quantitative mapping is 15% or more, 25% or more among them, and 37% or more among them of the total atomic concentration (100 at %) of Ce account for 80 or more, 85 or more among them, and 90 or more among them.

In addition, it is even more preferable that the catalyst particles in which the atomic concentration (at %) of Fe measured by quantitative mapping is 20% or more of the total atomic concentration (100 at %) of Fe and the atomic concentration (at %) of the M element measured by quantitative mapping is 20% or more of the total atomic concentration (100 at %) of the M element account for 80 or more, 85 or more among them, and 90 or more among them when 100 of catalyst particles having a particle diameter of 6 μm or more are randomly selected and each of these catalyst particles is quantitatively mapped by EDX.

At this time, the proportion of the atomic concentration (at %) of Fe with respect to the total atomic concentration (100 at %) of Fe is preferably 20% or more and even more preferably 22% or more among them.

In addition, the proportion of the atomic concentration (at %) of the M element with respect to the total atomic concentration (100 at %) of the M element is preferably 20% or more and even more preferably 32% or more among them.

Examples of the method for supporting iron (Fe), cerium (Ce), the M element, and the precious metal on the inorganic porous support without being unevenly distributed, respectively, that is, in a uniformly dispersed state as described above may include a method in which a solution containing iron, cerium, the M element, and a precious metal are mixed with a heated inorganic porous support powder and the amount of the solution to be mixed at this time is adjusted as well as the mixture is stirred to adsorb iron, cerium, the M element, and the precious metal on the inorganic porous support, and the resultant is calcined. However, it is not limited to this method.

(Supported Element)

In the present catalyst particles, the element to be supported on an inorganic porous support other than the precious metal is iron (Fe), cerium (Ce), and the M element (these are referred to as the “supported element”, respectively, and the composition composed of these is referred to as the “supported element composition”).

At this time, it is preferable that iron is present as iron oxide, cerium is present as cerium oxide, and the M element is present as an oxide of the M element.

Examples of the M element may include one or two or more kinds of elements among cobalt (Co), manganese (Mn), copper (Cu), nickel (Ni), magnesium (Mg), lanthanum (La), and strontium (Sr). The effect of these has all been confirmed in Examples to be described later. Among them, one or two or more kinds of elements among cobalt (Co), manganese (Mn), copper (Cu), nickel (Ni), magnesium (Mg), and lanthanum (La) are particularly preferable from the viewpoint of sintering suppressing effect.

Incidentally, in the present catalyst particles, it is preferable that carbon is not contained as a supported element. For example, Fe₃C exhibits high activity as the active site exhibiting the oxidative and reductive action. However, on the other hand, the simple substance of Fe₃C exhibits low heat resistance, and thus most of Fe₃C is oxidized to be an oxide such as Fe₂O₃ and the activity thereof greatly decreases when the aging treatment is conducted at 900 to 1000° C., for example. In addition, it is possible to enhance the dispersibility of the respective supported elements and the precious metal as carbon is not contained. Accordingly, it is preferable that carbon is not contained as an element to be supported on the inorganic porous support.

The present catalyst particles are catalyst particles having a configuration in which the supported element composition composed of iron, cerium, and the M element and a precious metal are supported on an inorganic porous support, and the present catalyst is those which contain the catalyst particles as the main component.

In the present catalyst, when the content of the supported element composition with respect to the inorganic porous support is 50 mass % or less, it is possible to prevent the composite oxide particles from being present in close contact with one another and to prevent the sintering of the present catalyst when being exposed to a high temperature, and thus it is possible to suppress a decrease in purification rate due to a decrease in effective area. On the other hand, when the content of the supported element composition with respect to the inorganic porous support is 1 mass % or more, it is possible to maintain the number of catalyst particles and to maintain the purification rate by the presence of effective active sites.

From this point of view, it is preferable that the content of the supported element composition with respect to the inorganic porous support is 1 to 50 mass %, and it is even more preferable that the content is 5 mass % or more or 40 mass % or less among them and 10 mass % or more or 30 mass % or less among them.

(Inorganic Porous Support)

Examples of the inorganic porous support may include an inorganic porous support composed of a compound selected from the group consisting of silica, alumina, and titania compounds or an OSC material such as ceria-zirconia composite oxide.

More specific examples thereof may include a porous powder composed of a compound selected from alumina, silica, silica-alumina, ceria, zirconia, ceria-zirconia, titania, an aluminosilicate, alumina-zirconia, alumina-chromia, or alumina-ceria.

As alumina, it is possible to use alumina having a specific surface area of larger than 50 m²/g, for example, γ, δ, θ, α-alumina. Among them, it is preferable to use γ- or θ-alumina. Incidentally, alumina can also contain a trace amount of lanthanum (La) in order to enhance the heat resistance.

Examples of the OSC material may include a cerium compound, a zirconium compound, and ceria-zirconia composite oxide.

(Precious Metal Component)

The amount of the precious metal supported in the present catalyst is preferably 0.01 mass % or more with respect to the present catalyst (100 mass %) and even more preferably 0.41 mass % or more among them in order to maintain the activity as a catalyst as well. However, it is difficult to expect the performance improvement commensurate with the cost even if the amount of the precious metal supported is increased to a certain amount or more. From this point of view, practically, it is preferable that the amount of the precious metal supported is 3 mass % or less and 2 mass % or less among them.

Examples of the precious metal may include palladium (Pd), platinum (Pt), rhodium (Rh), ruthenium (Ru), iridium (Ir), gold (Au), and silver (Ag), and it is possible to use one or two or more kinds in combination among these. Among them, palladium (Pd), platinum (Pt), and rhodium (Rh) are particularly preferable.

(Producing Method)

Next, an example of the producing method of the present catalyst will be described. However, it is not limited to the following producing method.

For example, it is possible to adsorb iron, cerium, the M element, and the precious metal on an inorganic porous support (adsorption step) by preparing a solution in which iron, cerium, the M element, and the precious metal are dissolved, and heating the solution in advance if necessary, adding this to a heated inorganic porous support, and stirring the mixture so as to absorb the solution into the inorganic porous support and to evaporate the moisture at the same time. Next, the resultant is dried, pulverized, and heated and calcined in an air atmosphere if necessary (calcination step), and the resultant is pulverized if necessary, whereby the present catalyst can be prepared. However, it is not limited to such a producing method.

When the catalyst is produced in such a manner, Fe, Ce, the M element, and the precious metal can be supported on an inorganic porous support in a uniformly dispersed state but without being unevenly distributed on the inorganic porous support as compared to the case of a co-precipitation method of the prior art.

In the adsorption step, it is preferable that the amount of the solution containing iron, cerium, the M element, and the precious metal to be mixed with an inorganic porous support powder is an amount in which the inorganic porous support powder can absorb the solution or a little smaller amount than that.

The reason for this is that, when the amount of the solution containing iron, cerium, the M element, and the precious metal to be mixed with an inorganic porous support powder is more than the amount in which the inorganic porous support powder can absorb the solution, the components are concentrated when the excess moisture of the solution is volatilized and thus the component concentration is biased so as to deteriorate the dispersibility.

In the adsorption step, a step of adsorbing iron, cerium, and the M element to the inorganic porous support and a step of adsorbing the precious metal to the inorganic porous support may be divided.

In addition, in the adsorption step, the inorganic porous material is preferably heated to 100 to 180° C. in advance and even more preferably heated to 130° C. or higher or 150° C. or lower in advance among them.

In addition, it is preferable that the solution containing iron, cerium, the M element, and the precious metal to be adsorbed to the inorganic porous material is also heated in advance, and it is even more preferable that the solution is heated in advance to 80 to 95° C. among them and to 90° C. or higher or 95° C. or lower among them. It is possible to further uniformly support the components by employing such a condition.

With regard to the heating and calcination conditions in the air atmosphere, there is a possibility that the components are not oxidized when the temperature is too low and there is a possibility that the particle diameter increases when the temperature is too high. In addition, there is a possibility that the oxidation does not proceed when the calcination time is too short. From this point of view, the inorganic porous support after the adsorption step may be heated so as to be maintained at a product temperature of 400 to 800° C. for 2 to 10 hours in the air atmosphere. It is particularly preferable that the inorganic porous support after the adsorption step is heated to 500° C. or higher or 700° C. or lower among them and to 550° C. or higher or 650° C. or lower among them, and it is preferable that the inorganic porous support after the adsorption step is heated for 2 hours or longer or 7 hours or shorter among them and for 3 hours or longer or 6 hours or shorter.

<Present Catalyst Structure>

It is possible to prepare an exhaust gas purifying catalyst structure having a catalyst layer containing the present catalyst.

An exhaust gas purifying catalyst structure (referred to as the “present catalyst structure”) can be prepared, for example, by forming a catalyst layer containing the present catalyst on a substrate.

It is possible to form a catalyst structure, for example, by wash-coating a catalyst composition containing the present catalyst on the surface of a substrate having a honeycomb (monolith) structure to form a catalyst layer.

(Substrate)

In the present catalyst structure, examples of the material for the substrate may include a ceramic or a metal material.

Examples of the material for the ceramic substrate may include a refractory ceramic material, for example, cordierite, alpha alumina, silicon nitride, zircon mullite, spodumene, alumina-silica magnesia, zircon silicate, sillimanite, magnesium silicate, zircon, petalite, and aluminosilicate.

Examples of the material for the metal substrate may include a refractory metal, for example, stainless steel or another suitable corrosion-resistant alloy which contains iron as the base.

Examples of the shape of the substrate may include a honeycomb shape, a pellet shape, and a spherical shape.

In the case of using a substrate having a honeycomb shape, for example, it is possible to use a monolithic substrate having a large number of gas flow passages, namely, channels which are fine and parallel to the inside of the substrate so that the fluid flows inside the substrate. At this time, it is possible to form a catalyst layer by coating the catalyst composition on the inner wall surface of each channel in the monolithic substrate through wash coating or the like.

(Catalyst Composition)

The catalyst composition for forming a catalyst layer of the present catalyst structure may further contain a stabilizer and other components if necessary in addition to the present catalyst described above.

It is possible to blend a stabilizer, for example, for the purpose of suppressing the reduction of palladium oxide (PdOx) to metallic Pd in the fuel-rich atmosphere.

Examples of this kind of stabilizer may include an alkaline earth metal and an alkali metal.

In addition, the catalyst composition may contain a known additive component such a binder component.

As the binder component, it is possible to use an aqueous solution of an inorganic binder, for example, alumina sol, silica sol, zirconia sol, or ceria sol. These can take the form of an inorganic oxide when being calcined.

(Producing Method)

As an example for producing the present catalyst structure, a method can be mentioned in which the present catalyst is added to and mixed with water, the solution is stirred using a ball mill or the like to prepare a slurry, a substrate, for example, a ceramic honeycomb body is immersed in this slurry, this is withdrawn therefrom and calcined, whereby a catalyst layer can be formed on the substrate surface.

However, it is possible to employ any known method as the method for producing the present catalyst, and it is not limited to the above example.

<Description of Phrase>

In the present specification, in a case in which it is expressed as “X to Y” (X and Y are an arbitrary number, respectively), it also includes the meaning of being “preferably greater than X” or “preferably less than Y” as well as the meaning of being “X or more and Y or less” unless otherwise stated.

In addition, in a case in which it is expressed as “X or more” (X is an arbitrary number) or “Y or less” (Y is an arbitrary number), it also includes the intention that “it is preferably greater than X” or “it is preferably less than Y”.

### EXAMPLES

Hereinafter, the invention will be described in more detail on the basis of the following Examples and Comparative Examples.

### Comparative Example 1

A mixed solution was prepared by dissolving iron nitrate(II) (nonahydrate), cerium nitrate(III) (hexahydrate), and cobalt nitrate(II) (hexahydrate) in deionized water and then introducing alumina powder thereinto while stirring.

At this time, the mass of iron nitrate(II) (nonahydrate), cerium nitrate(III) (hexahydrate), cobalt nitrate(II) (hexahydrate), and alumina powder which were used was adjusted such that the mass of the iron atom contained in iron nitrate(II) (nonahydrate) was 2 at %, the mass of the cerium atom contained in cerium nitrate(III) (hexahydrate) was 18 at %, and the mass of the cobalt atom contained in cobalt nitrate(II) (hexahydrate) was 2 at %, the mass of alumina was 78 at %, and the sum thereof was 100 at %.

Next, an aqueous solution of sodium carbonate was added to the mixed solution dropwise until the pH reached 10 to 11, and the mixture was stirred for 3 hours at a rotational speed of the stirrer of 600 rpm. Thereafter, the solution was filtered, the precipitate was washed with water two to three times, and the precipitate was dried in a dryer at 120° C. Subsequently, the dried precipitate was calcined at 500° C. for 3 hours in the air atmosphere and then pulverized using a mortar, thereby obtaining a catalyst composition powder (sample).

### Example 1

Iron nitrate(II) (nonahydrate), cerium nitrate(III) (hexahydrate), and cobalt nitrate(II) were dissolved in hot water at 90° C. or higher in an amount corresponding to the water consumption of alumina, and the solution was introduced into a container containing alumina powder that was heated to 100° C. while stirring.

At this time, the mass of iron nitrate(II) (nonahydrate), cerium nitrate(III) (hexahydrate), cobalt nitrate(II) (hexahydrate), and alumina powder which were used was adjusted such that the mass of the iron atom contained in iron nitrate(II) (nonahydrate) was 2 at %, the mass of the cerium atom contained in cerium nitrate(III) (hexahydrate) was 18 at %, and the mass of the cobalt atom contained in cobalt nitrate(II) (hexahydrate) was 2 at %, the mass of alumina was 78 at %, and the sum thereof was 100 at %.

Next, the resultant was dried at 120° C., then calcined at 500° C. for 3 hours, and subsequently pulverized using a mortar, thereby obtaining a catalyst composition powder (sample).

### Examples 2 to 7 and Comparative Examples 2 to 4

Catalyst composition powders (samples) were obtained by producing catalyst powders in the same manner as in Example 1 except that nitrates of various kinds of M elements presented in Table 1 were used instead of cobalt nitrate in Example 1.

### Examples 8 to 15 and Comparative Example 5

Catalyst composition powders (samples) were obtained by producing catalyst powders in the same manner as in Example 1 except that the respective blended amounts of cobalt, cerium, iron, and alumina were changed to those presented in Table 2 in Example 1.

### Comparative Example 6

A catalyst composition powder (sample) was obtained by producing a catalyst powder in the same manner as in Comparative Example 1 except that the respective blended amounts of cobalt, cerium, iron, and alumina were changed to those presented in Table 2 in Comparative Example 1.

<Total Atomic Concentration of Each Component>

The total atomic concentration (at %) of each element was calculated from the blended amount of each element.

<Confirmation of Dispersed State>

The EDX Mapping photographs of the catalyst composition powders obtained in Examples and Comparative Examples (samples) were obtained using a FE-SEM “JSM-7001F” manufactured by JEOL Ltd., and the dispersed state thereof was observed.

Incidentally, an EDX “INCA PentaFETx3” manufactured by Oxford Instruments as the EDX detector is mounted on the present FE-SEM.

<Quantifying Method of Each Component by EDX Quantitative Mapping>

The concentration (at %) of each element was quantified by randomly selecting 100 of catalyst particles having a particle diameter of 6 μm or more from the EDX Mapping image obtained using a FE-SEM “JSM-7001F” manufactured by JEOL Ltd. and quantitatively mapping these respective catalyst particles by EDX.

Incidentally, an EDX “INCA PentaFETx3” manufactured by Oxford Instruments as the EDX detector is mounted on the present FE-SEM.

The scanning was conducted under the measurement conditions having an acceleration voltage of 15 kV and an irradiation current of 13 mA, and the quantification was conducted by net count as the detection method and the Phi-Rho-Z method as the quantitative correction method.

<Catalytic Performance Test>

Pd-supported catalyst composition powders were prepared by supporting Pd on the catalyst composition powders (samples) obtained in Examples 1 to 15 and Comparative Examples 1 to 6. The amount of Pd supported was set to 1 wt % with respect to the catalyst composition powder (sample). This Pd-supporting catalyst composition powder was aged at 1000° C. for 25 hours while allowing the air to flow through the powder at 1 L/min, and the crystallite diameter of the fresh catalyst composition powders (samples) and the aged catalyst composition powders was measured as follows and the sintering suppressing effect was examined.

(Measurement of the Crystallite Diameter)

The measurement of crystallite diameter was conducted using an X-ray diffractometer “MINIFLEX600” manufactured by Rigaku Corporation. The K-ray of Cu was irradiated at a tube voltage output of 40 kV and a tube current output of 15 mA using a Cu tubular bulb as the radiation source, and the K-β ray was cut by a Ni filter.

The measurement was conducted under the measurement condition having a 2θ scanning range of 33 to 35 deg., a scanning speed of 1 deg./min, and a step of 0.01 deg., and the Scherrer's Equation, D=Kλ/(β cos δ) was used for the calculation of the crystallite diameter (D). Here, 0.94 was used for K as the Scherrer's constant, the wavelength of the Cu K-α ray, 1.54178 was used for λ, the half width of the peak was used for β, and the radian angle of the peak was used for θ.

Incidentally, it can be evaluated that the sintering of Pd is suppressed when an increase in the crystallite diameter of the catalyst particles is suppressed.

TABLE 1

| | | | | | | | | Crystallite |
|---|---|---|---|---|---|---|---|---|
| | Total atomic concentration | | | | Amount of | | Amount | diameter after |
| | | | | Amount | inorganic | | of | aging at |
| | | | | of M | porous | Kinds of | precious | 1000° C. for 25 |
| | Ce | Fe | Kinds of M | element | material | precious | metal | hours |
| | (at %) | (at %) | element | (at %) | (at %) | metal | (wt %) | (nm) |
| Comparative | 18 | 2 | Co | 2 | 78 | Pd | 1 | 44.8 |
| Example 1 | | | | | | | | |
| Example 1 | 18 | 2 | Co | 2 | 78 | Pd | 1 | 33.5 |
| Example 2 | 18 | 2 | Mn | 2 | 78 | Pd | 1 | 31.2 |
| Example 3 | 18 | 2 | Ni | 2 | 78 | Pd | 1 | 34.2 |
| Example 4 | 18 | 2 | Cu | 2 | 78 | Pd | 1 | 31.5 |
| Example 5 | 18 | 2 | Mg | 2 | 78 | Pd | 1 | 21.1 |
| Example 6 | 18 | 2 | La | 2 | 78 | Pd | 1 | 32.6 |
| Example 7 | 18 | 2 | Sr | 2 | 78 | Pd | 1 | 43.2 |
| Comparative | 18 | 2 | Pr | 2 | 78 | Pd | 1 | 51.4 |
| Example 2 | | | | | | | | |
| Comparative | 18 | 2 | Ca | 2 | 78 | Pd | 1 | 45.5 |
| Example 3 | | | | | | | | |
| Comparative | 18 | 2 | Zn | 2 | 78 | Pd | 1 | 60.4 |
| Example 4 | | | | | | | | |

*Pr, Ca, and Zn are not the “M element” but metal kinds for comparing with the “M element”.

TABLE 2

| | Total atomic | | | Amount of | | Amount of | Crystallite |
|---|---|---|---|---|---|---|---|
| | concentration | | | inorganic | Kinds of | precious | diameter after |
| | Ce | Fe | Co | porous material | precious | metal | aging at 1000° C. |
| | (at %) | (at %) | (at %) | (at %) | metal | (wt %) | for 25 hours (nm) |
| Example 8 | 18 | 2 | 10 | 70 | Pd | 1 | 33.9 |
| Example 9 | 18 | 0.5 | 2 | 79.5 | Pd | 1 | 38.9 |
| Example 10 | 18 | 10 | 2 | 70 | Pd | 1 | 34.8 |
| Example 11 | 18 | 20 | 2 | 60 | Pd | 1 | 42.1 |
| Comparative | 0 | 2 | 2 | 96 | Pd | 1 | 44.2 |
| Example 5 | | | | | | | |
| Example 12 | 6 | 2 | 2 | 90 | Pd | 1 | 33.5 |
| Example 13 | 30 | 2 | 2 | 66 | Pd | 1 | 42.1 |
| Example 14 | 3 | 0.5 | 0.5 | 96 | Pd | 1 | 29.1 |
| Example 15 | 36 | 4 | 4 | 56 | Pd | 1 | 34.4 |
| Comparative | 3 | 0.5 | 0.5 | 96 | Pd | 1 | 45.3 |
| Example 6 | | | | | | | |

TABLE 3

| | Quantitative | Quantitative | Quantitative | | Quantitative | Quantitative | Quantitative |
|---|---|---|---|---|---|---|---|
| | value of Ce | value of Fe | value of Co | | value of Ce | value of Fe | value of Co |
| | from | from | from | | from | from | from |
| | quantitative | quantitative | quantitative | | quantitative | quantitative | quantitative |
| | EDX | EDX | EDX | | EDX | EDX | EDX |
| Example | mapping | mapping | mapping | Comparative | mapping | mapping | mapping |
| 14 | (at %) | (at %) | (at %) | Example 6 | (at %) | (at %) | (at %) |
| Particle 1 | 1.75 | 0.17 | 0.12 | Particle 1 | 0.32 | 0.49 | 0.42 |
| Particle 2 | 1.45 | 0.33 | 0.30 | Particle 2 | 0.41 | 0.53 | 0.43 |
| Particle 3 | 1.21 | 0.38 | 0.27 | Particle 3 | 0.21 | 0.19 | 0.18 |
| Particle 4 | 1.33 | 0.26 | 0.26 | Particle 4 | 0.37 | 0.31 | 0.26 |
| Particle 5 | 1.70 | 0.53 | 0.45 | Particle 5 | 0.44 | 0.35 | 0.27 |
| Particle 6 | 1.20 | 0.21 | 0.14 | Particle 6 | 0.35 | 0.24 | 0.22 |
| Particle 7 | 1.11 | 0.24 | 0.20 | Particle 7 | 0.39 | 0.25 | 0.22 |
| Particle 8 | 1.64 | 0.32 | 0.26 | Particle 8 | 0.45 | 0.33 | 0.08 |
| Particle 9 | 1.26 | 0.21 | 0.14 | Particle 9 | 0.40 | 0.33 | 0.35 |
| Particle | 1.19 | 0.28 | 0.26 | Particle 10 | 0.45 | 0.13 | 0.20 |
| 10 | | | | | | | |
| Particle | 1.61 | 0.28 | 0.17 | Particle 11 | 0.41 | 0.23 | 0.19 |
| 11 | | | | | | | |
| Particle | 1.42 | 0.27 | 0.23 | Particle 12 | 0.44 | 0.29 | 0.28 |
| 12 | | | | | | | |
| Particle | 1.23 | 0.29 | 0.28 | Particle 13 | 0.37 | 0.31 | 0.32 |
| 13 | | | | | | | |
| Particle | 1.19 | 0.31 | 0.32 | Particle 14 | 0.29 | 0.45 | 0.40 |
| 14 | | | | | | | |
| Particle | 1.16 | 0.19 | 0.22 | Particle 15 | 0.40 | 0.28 | 0.22 |
| 15 | | | | | | | |
| Particle | 1.53 | 0.28 | 0.21 | Particle 16 | 0.28 | 0.28 | 0.23 |
| 16 | | | | | | | |
| Particle | 1.40 | 0.36 | 0.32 | Particle 17 | 0.29 | 0.32 | 0.29 |
| 17 | | | | | | | |
| Particle | 1.67 | 0.28 | 0.28 | Particle 18 | 0.33 | 0.29 | 0.26 |
| 18 | | | | | | | |
| Particle | 1.32 | 0.14 | 0.25 | Particle 19 | 0.41 | 0.15 | 0.21 |
| 19 | | | | | | | |
| Particle | 1.49 | 0.38 | 0.19 | Particle 20 | 0.38 | 0.32 | 0.23 |
| 20 | | | | | | | |
| Particle | 1.63 | 0.25 | 0.33 | Particle 21 | 0.30 | 0.18 | 0.09 |
| 21 | | | | | | | |
| Particle | 1.44 | 0.34 | 0.32 | Particle 22 | 0.41 | 0.24 | 0.22 |
| 22 | | | | | | | |
| Particle | 1.50 | 0.27 | 0.13 | Particle 23 | 0.41 | 0.37 | 0.33 |
| 23 | | | | | | | |
| Particle | 1.36 | 0.18 | 0.28 | Particle 24 | 0.38 | 0.26 | 0.26 |
| 24 | | | | | | | |
| Particle | 1.28 | 0.12 | 0.09 | Particle 25 | 0.32 | 0.22 | 0.19 |
| 25 | | | | | | | |
| Particle | 1.61 | 0.22 | 0.24 | Particle 26 | 0.39 | 0.23 | 0.19 |
| 26 | | | | | | | |
| Particle | 1.52 | 0.29 | 0.37 | Particle 27 | 0.33 | 0.29 | 0.36 |
| 27 | | | | | | | |
| Particle | 1.50 | 0.31 | 0.27 | Particle 28 | 0.38 | 0.31 | 0.27 |
| 28 | | | | | | | |
| Particle | 1.34 | 0.18 | 0.08 | Particle 29 | 0.44 | 0.28 | 0.11 |
| 29 | | | | | | | |
| Particle | 1.48 | 0.25 | 0.14 | Particle 30 | 0.39 | 0.32 | 0.23 |
| 30 | | | | | | | |
| Particle | 1.71 | 0.34 | 0.45 | Particle 31 | 0.40 | 0.17 | 0.15 |
| 31 | | | | | | | |
| Particle | 1.43 | 0.25 | 0.21 | Particle 32 | 0.29 | 0.27 | 0.22 |
| 32 | | | | | | | |
| Particle | 1.47 | 0.24 | 0.30 | Particle 33 | 0.24 | 0.26 | 0.24 |
| 33 | | | | | | | |
| Particle | 1.29 | 0.29 | 0.24 | Particle 34 | 0.27 | 0.28 | 0.23 |
| 34 | | | | | | | |
| Particle | 1.37 | 0.25 | 0.21 | Particle 35 | 0.30 | 0.24 | 0.22 |
| 35 | | | | | | | |
| Particle | 1.33 | 0.18 | 0.17 | Particle 36 | 0.33 | 0.28 | 0.27 |
| 36 | | | | | | | |
| Particle | 1.42 | 0.19 | 0.20 | Particle 37 | 0.41 | 0.21 | 0.14 |
| 37 | | | | | | | |
| Particle | 1.53 | 0.25 | 0.38 | Particle 38 | 0.43 | 0.26 | 0.16 |
| 38 | | | | | | | |
| Particle | 1.60 | 0.29 | 0.26 | Particle 39 | 0.43 | 0.28 | 0.17 |
| 39 | | | | | | | |
| Particle | 1.52 | 0.30 | 0.27 | Particle 40 | 0.33 | 0.48 | 0.38 |
| 40 | | | | | | | |
| Particle | 1.45 | 0.28 | 0.28 | Particle 41 | 0.39 | 0.29 | 0.25 |
| 41 | | | | | | | |
| Particle | 1.30 | 0.37 | 0.38 | Particle 42 | 0.37 | 0.39 | 0.08 |
| 42 | | | | | | | |
| Particle | 1.22 | 0.44 | 0.32 | Particle 43 | 0.43 | 0.43 | 0.31 |
| 43 | | | | | | | |
| Particle | 1.53 | 0.18 | 0.20 | Particle 44 | 0.34 | 0.19 | 0.23 |
| 44 | | | | | | | |
| Particle | 1.26 | 0.56 | 0.48 | Particle 45 | 0.45 | 0.32 | 0.30 |
| 45 | | | | | | | |
| Particle | 1.19 | 0.12 | 0.08 | Particle 46 | 0.37 | 0.23 | 0.11 |
| 46 | | | | | | | |
| Particle | 1.49 | 0.13 | 0.11 | Particle 47 | 0.28 | 0.27 | 0.24 |
| 47 | | | | | | | |
| Particle | 1.53 | 0.60 | 0.50 | Particle 48 | 0.36 | 0.18 | 0.17 |
| 48 | | | | | | | |
| Particle | 1.39 | 0.11 | 0.22 | Particle 49 | 0.41 | 0.22 | 0.24 |
| 49 | | | | | | | |
| Particle | 1.28 | 0.13 | 0.08 | Particle 50 | 0.43 | 0.32 | 0.23 |
| 50 | | | | | | | |
| Particle | 1.55 | 0.36 | 0.16 | Particle 51 | 0.29 | 0.27 | 0.22 |
| 51 | | | | | | | |
| Particle | 1.39 | 0.15 | 0.18 | Particle 52 | 0.34 | 0.25 | 0.22 |
| 52 | | | | | | | |
| Particle | 1.38 | 0.46 | 0.42 | Particle 53 | 0.37 | 0.13 | 0.31 |
| 53 | | | | | | | |
| Particle | 1.42 | 0.35 | 0.13 | Particle 54 | 0.36 | 0.14 | 0.17 |
| 54 | | | | | | | |
| Particle | 1.54 | 0.19 | 0.47 | Particle 55 | 0.41 | 0.56 | 0.15 |
| 55 | | | | | | | |
| Particle | 1.62 | 0.14 | 0.14 | Particle 56 | 0.36 | 0.45 | 0.25 |
| 56 | | | | | | | |
| Particle | 1.34 | 0.31 | 0.23 | Particle 57 | 0.42 | 0.18 | 0.20 |
| 57 | | | | | | | |
| Particle | 1.54 | 0.29 | 0.10 | Particle 58 | 0.37 | 0.19 | 0.15 |
| 58 | | | | | | | |
| Particle | 1.37 | 0.13 | 0.18 | Particle 59 | 0.34 | 0.43 | 0.36 |
| 59 | | | | | | | |
| Particle | 1.44 | 0.51 | 0.32 | Particle 60 | 0.42 | 0.10 | 0.25 |
| 60 | | | | | | | |
| Particle | 1.31 | 0.39 | 0.45 | Particle 61 | 0.39 | 0.42 | 0.18 |
| 61 | | | | | | | |
| Particle | 1.42 | 0.16 | 0.19 | Particle 62 | 0.40 | 0.17 | 0.32 |
| 62 | | | | | | | |
| Particle | 1.38 | 0.20 | 0.13 | Particle 63 | 0.35 | 0.13 | 0.27 |
| 63 | | | | | | | |
| Particle | 1.48 | 0.14 | 0.37 | Particle 64 | 0.33 | 0.21 | 0.08 |
| 64 | | | | | | | |
| Particle | 1.33 | 0.33 | 0.35 | Particle 65 | 0.30 | 0.20 | 0.11 |
| 65 | | | | | | | |
| Particle | 1.34 | 0.17 | 0.14 | Particle 66 | 0.35 | 0.18 | 0.17 |
| 66 | | | | | | | |
| Particle | 1.39 | 0.24 | 0.12 | Particle 67 | 0.28 | 0.14 | 0.25 |
| 67 | | | | | | | |
| Particle | 1.27 | 0.13 | 0.19 | Particle 68 | 0.29 | 0.31 | 0.16 |
| 68 | | | | | | | |
| Particle | 1.36 | 0.15 | 0.22 | Particle 69 | 0.41 | 0.59 | 0.12 |
| 69 | | | | | | | |
| Particle | 1.40 | 0.27 | 0.35 | Particle 70 | 0.35 | 0.35 | 0.41 |
| 70 | | | | | | | |
| Particle | 1.32 | 0.34 | 0.09 | Particle 71 | 0.33 | 0.16 | 0.27 |
| 71 | | | | | | | |
| Particle | 1.45 | 0.12 | 0.18 | Particle 72 | 0.44 | 0.12 | 0.26 |
| 72 | | | | | | | |
| Particle | 1.49 | 0.40 | 0.23 | Particle 73 | 0.39 | 0.14 | 0.31 |
| 73 | | | | | | | |
| Particle | 1.34 | 0.12 | 0.11 | Particle 74 | 0.37 | 0.20 | 0.14 |
| 74 | | | | | | | |
| Particle | 1.26 | 0.59 | 0.29 | Particle 75 | 0.35 | 0.19 | 0.56 |
| 75 | | | | | | | |
| Particle | 1.59 | 0.16 | 0.32 | Particle 76 | 0.37 | 0.23 | 0.31 |
| 76 | | | | | | | |
| Particle | 1.30 | 0.18 | 0.13 | Particle 77 | 0.30 | 0.34 | 0.47 |
| 77 | | | | | | | |
| Particle | 1.37 | 0.31 | 0.18 | Particle 78 | 0.33 | 0.17 | 0.42 |
| 78 | | | | | | | |
| Particle | 1.19 | 0.24 | 0.52 | Particle 79 | 0.40 | 0.23 | 0.09 |
| 79 | | | | | | | |
| Particle | 1.35 | 0.17 | 0.13 | Particle 80 | 0.39 | 0.16 | 0.36 |
| 80 | | | | | | | |
| Particle | 1.31 | 0.46 | 0.17 | Particle 81 | 0.31 | 0.54 | 0.15 |
| 81 | | | | | | | |
| Particle | 1.62 | 0.38 | 0.14 | Particle 82 | 0.41 | 0.43 | 0.18 |
| 82 | | | | | | | |
| Particle | 1.45 | 0.13 | 0.21 | Particle 83 | 0.37 | 0.13 | 0.33 |
| 83 | | | | | | | |
| Particle | 1.28 | 0.21 | 0.30 | Particle 84 | 0.38 | 0.29 | 0.40 |
| 84 | | | | | | | |
| Particle | 1.38 | 0.41 | 0.41 | Particle 85 | 0.34 | 0.21 | 0.27 |
| 85 | | | | | | | |
| Particle | 1.44 | 0.19 | 0.09 | Particle 86 | 0.28 | 0.36 | 0.31 |
| 86 | | | | | | | |
| Particle | 1.34 | 0.37 | 0.24 | Particle 87 | 0.25 | 0.15 | 0.38 |
| 87 | | | | | | | |
| Particle | 1.47 | 0.20 | 0.17 | Particle 88 | 0.28 | 0.10 | 0.21 |
| 88 | | | | | | | |
| Particle | 1.39 | 0.53 | 0.24 | Particle 89 | 0.38 | 0.18 | 0.17 |
| 89 | | | | | | | |
| Particle | 1.27 | 0.45 | 0.13 | Particle 90 | 0.39 | 0.27 | 0.19 |
| 90 | | | | | | | |
| Particle | 1.40 | 0.16 | 0.16 | Particle 91 | 0.42 | 0.39 | 0.13 |
| 91 | | | | | | | |
| Particle | 1.44 | 0.12 | 0.19 | Particle 92 | 0.38 | 0.35 | 0.26 |
| 92 | | | | | | | |
| Particle | 1.38 | 0.39 | 0.23 | Particle 93 | 0.36 | 0.42 | 0.21 |
| 93 | | | | | | | |
| Particle | 1.35 | 0.26 | 0.15 | Particle 94 | 0.35 | 0.13 | 0.09 |
| 94 | | | | | | | |
| Particle | 1.42 | 0.15 | 0.09 | Particle 95 | 0.40 | 0.23 | 0.17 |
| 95 | | | | | | | |
| Particle | 1.24 | 0.17 | 0.18 | Particle 96 | 0.37 | 0.24 | 0.15 |
| 96 | | | | | | | |
| Particle | 1.33 | 0.34 | 0.13 | Particle 97 | 0.41 | 0.13 | 0.27 |
| 97 | | | | | | | |
| Particle | 1.42 | 0.49 | 0.24 | Particle 98 | 0.40 | 0.54 | 0.11 |
| 98 | | | | | | | |
| Particle | 1.40 | 0.25 | 0.52 | Particle 99 | 0.42 | 0.26 | 0.10 |
| 99 | | | | | | | |
| Particle | 1.35 | 0.13 | 0.10 | Particle 100 | 0.44 | 0.31 | 0.48 |
| 100 | | | | | | | |
| Average | 1.40 | 0.27 | 0.24 | Average | 0.36 | 0.27 | 0.24 |
| concentration | | | | concentration | | | |
| (at %) | | | | (at %) | | | |
| Minimum | 1.11 | 0.11 | 0.08 | Maximum | 0.45 | 0.10 | 0.08 |
| concentration | | | | concentration | | | |
| (at %) | | | | (at %) | | | |

TABLE 4

| | Quantitative | | Quantitative |
|---|---|---|---|
| | value of Ce | | value of Ce |
| | from quanti- | | from quanti- |
| | tative EDX | Comparative | tative EDX |
| Example 14 | mapping | Example 6 | mapping |
| Average | 1.40 | Average | 0.36 |
| concentration | | concentration | |
| (at %) | | (at %) | |
| Minimum | 1.11 | Maximum | 0.45 |
| concentration | | concentration | |
| (at %) | | (at %) | |
| Total atomic | 3 | Total atomic | 3 |
| concentration | | concentration | |
| (at %) | | (at %) | |
| Minimum | 37.0% | Maximum | 15.0% |
| concentration from | | concentration from | |
| quantitative EDX | | quantitative EDX | |
| mapping to total | | mapping to total | |
| atomic | | atomic | |
| concentration | | concentration | |

### RESULTS AND DISCUSSION

It has been confirmed by the powder XRD analysis that iron (Fe), cerium (Ce), the M element, and the precious metal are supported on the inorganic porous support in a state of not forming a chemical bond to one another in any of the catalyst composition powders (samples) obtained in Examples 1 to 15.

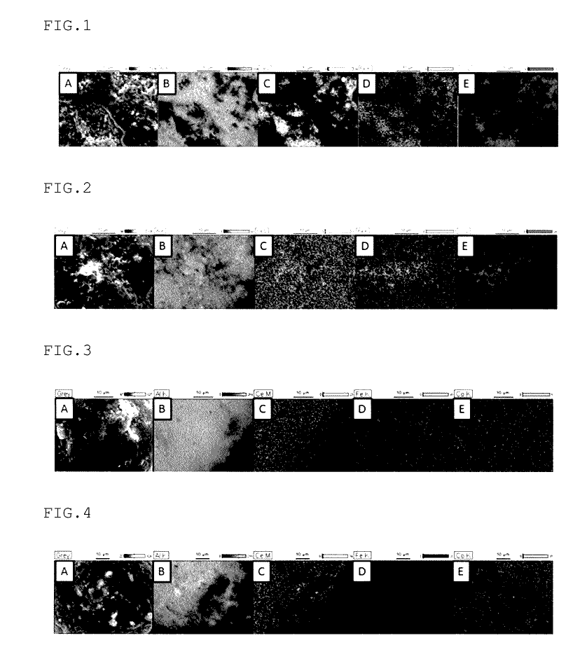

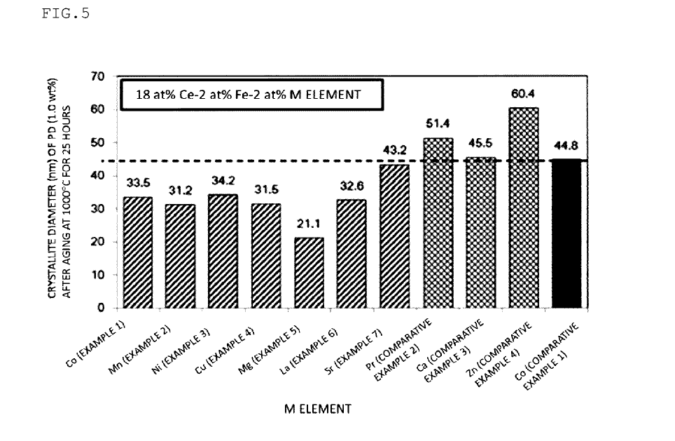

In addition, as illustrated in FIGS. 2 to 4, it has been found that the cerium, iron, and cobalt components are uniformly covered on the surface of the alumina support without unevenness in any of the catalyst composition powders (samples) obtained in Examples.

On the contrary, it has not been acknowledged that the cerium, iron, and cobalt components are uniformly covered on the surface of the alumina support without unevenness in the catalyst composition powder (sample) obtained in Comparative Example 1.

Moreover, it has been possible to suppress the sintering under a high temperature condition in any of the catalyst composition powders (samples) obtained in Examples as compared to the catalyst composition powder (sample) obtained in Comparative Example 1.

In any of the catalyst composition powders (samples) obtained in Examples, it has been possible to confirm that the catalyst particles having a configuration in which Ce is present at 1 at % or more, Fe is present at 0.1 at % or more, and the M element is present at 0.1 at % or more account for most and at least 80 or more when 100 of catalyst particles having a particle diameter of 6 μm or more are randomly selected and each of these catalyst particles is quantitatively mapped by EDX.

On the contrary, in both of the catalyst composition powders (samples) obtained in Comparative Examples 1 and 6, the catalyst particles having a configuration in which Ce is present at 1 at % or more, Fe is present at 0.1 at % or more, and the M element is present at 0.1 at % or more account for less than 80 when 100 of catalyst particles having a particle diameter of 6 μm or more are randomly selected and each of these catalyst particles is quantitatively mapped by EDX. As a representative example, the analytical results for Example 14 and Comparative Example 6 are presented in Table 3.

In Example 14 and Comparative Example 6, the amount of each component blended is the same although the producing methods are different from each other. In other words, in both of them, the total atomic concentration at which cerium, iron, and cobalt of the surface covering components are the least is 3 at % for cerium, 0.5 at % for iron, and 0.5 at % for cobalt, respectively.

As can be seen from Table 3, it can be considered that it is preferable that Ce is present at 1 at % or more and both of Fe and the M element are respectively present at 0.1 at % or more when these Comparative Example 6 and Example 14 are compared to each other.

It can be considered that one or two or more kinds of elements among Co, Mn, Cu, Ni, Mg, La, and Sr are preferable as the M element from the viewpoint of the sintering suppressing effect when Examples 1 to 7 are compared to Comparative Examples 2 to 4.

Furthermore, it has been found that the total atomic concentration of cobalt (Co), namely, the M element is preferably 0.1 to 10 at % and it is even more preferably 1 at % or more or 10 at % or less among them and 2 at % or more or 10 at % or less among them from the viewpoint of the sintering suppressing effect in the case of being exposed to a high temperature.

It has been found that the total atomic concentration of cerium (Ce) is preferably 1 to 36 at % and particularly 1 to 30 at % and it is particularly preferably 3 at % or more or 25 at % or less among them and 6 at % or more or 20 at % or less among them from the viewpoint of the sintering suppressing effect in the case of being exposed to a high temperature.

It has been found that the total atomic concentration of iron (Fe) is preferably 0.1 to 20 at % and it is even more preferably 0.5 at % or more or 10 at % or less among them and 2 at % or more or 5 at % or less among them from the viewpoint of the sintering suppressing effect in the case of being exposed to a high temperature.

From the results described above, in the total atomic concentration, namely, the blended amount of each element, it can be considered that it is preferable that the catalyst particles in which the atomic concentration (at %) of Ce measured by quantitative mapping is 15% or more of the total atomic concentration (100 at %) of Ce account for many and specifically 80 or more, 85 or more among them, and 90 or more among them when 100 of catalyst particles having a particle diameter of 6 m or more are randomly selected and each of these catalyst particles is quantitatively mapped by EDX.

From the same point of view, it can be considered that it is preferable that the catalyst particles in which the atomic concentration (at %) of Fe measured by quantitative mapping is 20% or more of the total atomic concentration (100 at %) of Fe account for many and specifically 80 or more, 85 or more among them, and 90 or more among them.

In the same manner, it can be considered that it is preferable that the catalyst particles in which the atomic concentration (at %) of the M element measured by quantitative mapping is 20% or more of the total atomic concentration (100 at %) of the M element account for many and specifically 80 or more, 85 or more among them, and 90 or more among them.

The data on Ce excerpted from the data in Table 3 are summarized in Table 4.

From this Table 4, it is possible to further suppress the sintering in the case of being exposed to a high temperature and to further enhance the durability to a severe temperature change when the atomic concentration of each element supported on the inorganic porous support with respect to the blended amount, namely, the added amount of each of Ce, Fe, and the M element is higher, and thus it can be considered that it is preferable that the catalyst particles in which the atomic concentration (at %) of Ce measured by quantitative mapping is 15% or more, 25% or more among them, and 37% or more among them of the total atomic concentration (100 at %) of Ce account for many, for example, with regard to Ce.

In the same manner, it can be considered that it is preferable that the catalyst particles in which the atomic concentration (at %) of Fe measured by quantitative mapping is 20% or more and 22% or more among them of the total atomic concentration (100 at %) of Fe account for many, for example, with regard to Fe.

In the same manner, it can be considered that it is preferable that the catalyst particles in which the atomic concentration (at %) of the M element measured by quantitative mapping is 20% or more and 32% or more among them of the total atomic concentration (100 at %) of the M element account for many, for example, with regard to the M element.

1. An exhaust gas purifying catalyst comprising catalyst particles having a configuration in which iron (Fe), cerium (Ce), and a precious metal, and one or two or more kinds of elements (referred to as the “M element”) among cobalt (Co), manganese (Mn), copper (Cu), nickel (Ni), magnesium (Mg), lanthanum (La), and strontium (Sr) are supported on inorganic porous support particles, wherein
catalyst particles having a configuration in which Ce is present at 1 at % or more, Fe is present at 0.1 at % or more, and the M element is present at 0.1 at % or more account for 80 or more when 100 of catalyst particles having a particle diameter of 6 μm or more are randomly selected and each of these catalyst particles is quantitatively mapped by EDX.

2. The exhaust gas purifying catalyst according to claim 1, wherein a total atomic concentration of iron (Fe) is 0.1 to 20 at %, a total atomic concentration of cerium (Ce) is 1 to 36 at %, and a total atomic concentration of the M element is 0.1 to 10 at %.

3. The exhaust gas purifying catalyst according to claim 2, wherein catalyst particles in which an atomic concentration (at %) of Ce measured by quantitative mapping is 15% or more of the total atomic concentration (100 at %) of Ce account for 80 or more when 100 of catalyst particles having a particle diameter of 6 μm or more are randomly selected and each of these catalyst particles is quantitatively mapped by EDX.

4. The exhaust gas purifying catalyst according to claim 2, wherein catalyst particles in which an atomic concentration (at %) of Fe measured by quantitative mapping is 20% or more of the total atomic concentration (100 at %) of Fe and an atomic concentration (at %) of the M element measured by quantitative mapping is 20% or more of the total atomic concentration (100 at %) of the M element account for 80 or more when 100 of catalyst particles having a particle diameter of 6 μm or more are randomly selected and each of these catalyst particles is quantitatively mapped by EDX.

5. An exhaust gas purifying catalyst structure comprising a catalyst layer containing the exhaust gas purifying catalyst according to claim 1.

6. The exhaust gas purifying catalyst according to claim 3, wherein catalyst particles in which an atomic concentration (at %) of Fe measured by quantitative mapping is 20% or more of the total atomic concentration (100 at %) of Fe and an atomic concentration (at %) of the M element measured by quantitative mapping is 20% or more of the total atomic concentration (100 at %) of the M element account for 80 or more when 100 of catalyst particles having a particle diameter of 6 μm or more are randomly selected and each of these catalyst particles is quantitatively mapped by EDX.

7. An exhaust gas purifying catalyst structure comprising a catalyst layer containing the exhaust gas purifying catalyst according to claim 2.

8. An exhaust gas purifying catalyst structure comprising a catalyst layer containing the exhaust gas purifying catalyst according to claim 3.

9. An exhaust gas purifying catalyst structure comprising a catalyst layer containing the exhaust gas purifying catalyst according to claim 4.
